(19) United States
(12) Patent Application Publication
(10) Pub. No.: US 2026/0131328 A1
(43) Pub. Date: May 14, 2026

(54) ON-CHIP MULTI CHAMBER LIGHT INDUCED AND MONITORING KIT

(71) Applicant: Purdue Research Foundation, West Lafayette, IN (US)

(72) Inventor: Afshin Izadian, Carmel, IN (US)

(73) Assignee: Purdue Research Foundation, West Lafayette, IN (US)

(21) Appl. No.: 19/373,591

(22) Filed: Oct. 29, 2025

Related U.S. Application Data
(60) Provisional application No. 63/719,145, filed on Nov. 12, 2024.

(51) Int. Cl. B01L 3/00

(52) U.S. Cl. CPC B01L 3/502715; B01L 2300/044; B01L 2300/0829; B01L 2300/0861; B01L 2300/165

(57) ABSTRACT

A Lab-On-Chip (LOC) system includes a multi-chamber tray having at least two chambers separated by a barrier, one or more light chambers each having a top portion and a bottom portion, and configured to be coupled to each chamber of the multi-chamber tray and further configured to allow selective light from the top portion of the light chamber, while blocking surrounding light, and one or more light sources, each coupled to a top portion of a corresponding one or more light chamber, wherein each of the one or more light sources is selectively configured to provide light at a predetermined wavelength, a predetermined frequency, and a predetermined intensity.

### CROSS-REFERENCE TO RELATED APPLICATIONS

The present non-provisional patent application is related to and claims the priority benefit of U.S. Provisional Patent Application Ser. 63/719,145, filed Nov. 12, 2024, the contents of which are hereby incorporated by reference in its entirety into the present disclosure.

### STATEMENT REGARDING GOVERNMENT FUNDING

None.

### TECHNICAL FIELD

The present disclosure generally relates to a Lab-On-Chip and in particular to a Lab-On-Chip arrangement including selective light excitation and selective mixing and pathways.

### BACKGROUND

This section introduces aspects that may help facilitate a better understanding of the disclosure. Accordingly, these statements are to be read in this light and are not to be understood as admissions about what is or is not prior art.

Lab-On-Chip systems have been prevalently used in various fields, including clinical testing and monitoring. In the field of clinical testing, as an example, Lab-On-Chip systems are used to test and measure specific reactions and interactions between chemicals and biological materials.

Additionally, various constituents react differently to light. For example, light of different wavelengths, pulse rates and intensity may cause different reactions on one type of constituent vs. light of another wavelength, pulse rate and intensity.

However, there are limited solutions present to allow researchers to study, measure, and analyze how each of two classes of constituents behave with light having varying wavelengths and how those two classes of constituents behave if selectively allowed to mix.

Therefore, there is an unmet need for a novel system that allows application of light of a predetermined wavelength to a first constituent and further allows selective mixing of the first constituent with a second constituent and yet allows inspection of these two constituents under a microscope each alone or during the mixing process.

### SUMMARY

A Lab-On-Chip (LOC) system is disclosed. The LOC includes a multi-chamber tray having at least two chambers separated by a barrier, one or more light chambers each having a top portion and a bottom portion, and configured to be coupled to each chamber of the multi-chamber tray and further configured to allow selective light from the top portion of the light chamber, while blocking surrounding light, and one or more light sources, each coupled to a top portion of a corresponding one or more light chamber. Each of the one or more light sources is selectively configured to provide light at a predetermined wavelength, a predetermined frequency, and a predetermined intensity.

In the above LOC system, the barrier is at least one of a solid barrier configured to prevent transference of constituents from one chamber to a neighboring chamber, a removable barrier thus allowing transference of constituents from one chamber to a neighboring chamber, a barrier having a solid portion and a dissolvable portion configured to prevent transference of constituents from one chamber to a neighboring chamber, and wherein the dissolvable portion is dissolvable after a predetermined amount of time, and a barrier with a solid portion a hydrophobic portion configured to prevent transference of constituents from one chamber to a neighboring chamber, and wherein the hydrophobic portion is reversibly configured to be converted to a hydrophilic portion thus allowing transference of constituents from one chamber to a neighboring chamber when energy is applied to said hydrophilic portion.

In the above LOC system, the dissolvable portion is made of Poly(lactic-co-glycolic acid) (PLGA) 15:85, PLGA 50:50, a hydrogel, or a combination thereof.

In the above LOC system, the one or more light sources are configured to provide a steady state light of a selectable intensity.

In the above LOC system, the one or more light sources are configured to provide light pulses.

In the above LOC system, an upper limit of the pulse frequency is 20 KHz.

In the above LOC system, the one or more light sources are configured to provide light at a predetermined intensity having an upper limit of 10,000 lux.

In the above LOC system, each of the one or more light chambers includes tabs that interface with depressions formed on the multi-chamber tray.

In the above LOC system, the tabs are removable.

In the above LOC system, the tabs are spring loaded, allowing access to a corresponding chamber when pulled back or pushed in and wherein the tabs return to a closure position when released.

A method of mixing constituents on a Lab-On-Chip (LOC) system is also disclosed. The method includes providing a plurality of constituents, each in a corresponding chamber in a multi-chamber tray, each chamber separated from a neighboring chamber by a barrier, coupling a plurality of light chambers each having a top portion and a bottom portion to each chamber of the multi-chamber tray and further configured to allow selective light from the top portion of the corresponding light chamber, while blocking surrounding light including light from a neighboring light chamber, and applying light by a plurality of light sources, each coupled to a top portion of a corresponding light chamber. Each of the one or more light sources is selectively configured to provide light at a predetermined wavelength, a predetermined frequency, and a predetermined intensity.

In the above method, the barrier is at least one of a solid barrier configured to prevent transference of constituents from one chamber to a neighboring chamber, a removable barrier thus allowing transference of constituents from one chamber to a neighboring chamber, a barrier having a solid portion and a dissolvable portion configured to prevent transference of constituents from one chamber to a neighboring chamber, and wherein the dissolvable portion is dissolvable after a predetermined amount of time, and a barrier with a solid portion a hydrophobic portion configured to prevent transference of constituents from one chamber to a neighboring chamber, and wherein the hydrophobic portion is reversibly configured to be converted to a hydrophilic portion thus allowing transference of constituents from one chamber to a neighboring chamber when energy is applied to said hydrophilic portion.

In the above method, the dissolvable portion is made of Poly(lactic-co-glycolic acid) (PLGA) 15:85, PLGA 50:50, a hydrogel, or a combination thereof.

In the above method, the plurality of light sources are configured to provide a steady state light of a selectable intensity.

In the above method, the plurality of light sources are configured to provide light pulses.

In the above method, an upper limit of the pulse frequency is 20 KHz.

In the above method, the plurality of light sources are configured to provide light at a predetermined intensity having an upper limit of 10,000 lux.

In the above method, each of the plurality of light chambers includes tabs that interface with depressions formed on the multi-chamber tray.

In the above method, the tabs are removable.

In the above method, the tabs are spring loaded, allowing access to a corresponding chamber when pulled back or pushed in and wherein the tabs return to a closure position when released.

### BRIEF DESCRIPTION OF DRAWINGS

FIG. 1 is an exploded schematic of a Lab-On-Chip system, according to the present disclosure.

FIG. 2 is a photograph of the Lab-On-Chip system in a partially assembled fashion.

FIG. 3 is a schematic which shows a barrier of the present disclosure includes a dissolvable portion towards the bottom section of the barrier.

FIG. 4 is an embodiment of the barrier which includes a removable portion and a hydrophobic portion.

FIG. 5 is a circuit showing the device of the present disclosure coupled to a voltage source.

FIG. 6 is a photograph of a multi-chamber tray with two chambers on a microscope slide.

### DETAILED DESCRIPTION

Lab-On-Chip system For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

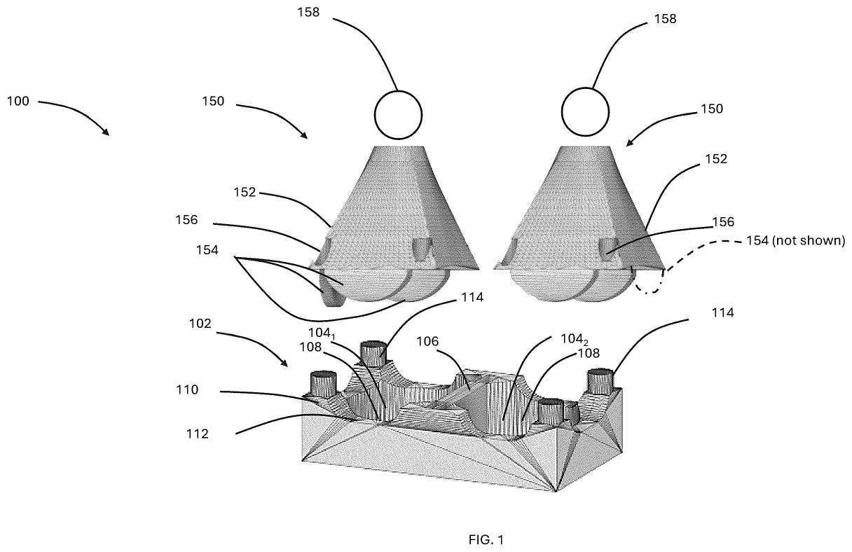

A novel system that allows application of light of a predetermined wavelength to a first constituent and further allows selective mixing of the first constituent with a second constituent and yet allows inspection of these two constituents under a microscope each alone or during the mixing process. Referring to FIG. 1, an exploded schematic of a Lab-On-Chip system 100, according to the present disclosure, is shown. The Lab-On-Chip system 100 includes a multi-chamber tray 102 having two or more chambers 104 (104₁,104₂). The Lab-On-Chip system 100 of FIG. 1 shows a two-chamber multi-chamber tray 102, however, more than two chambers 104₁,104₂ are within the scope of the present disclosure. In the Lab-On-Chip system 100 shown in FIG. 1, the first chamber 104₁ is separated from the second chamber 104₂ by a barrier 106. Each of the first and second chambers 104₁,104₂ are configured to hold a respective constituent. Each chamber is formed as a cavity 108 surrounded by an envelope 110 having one or more depressions 112 formed therein. These depressions 112 are configured to provide access to the cavity 108 from outside. Furthermore, each of the first and second chambers 104₁, 104₂ includes one or more mounting interfaces 114.

The barrier 106 includes multiple parts, as discussed below, allowing transference of one constituent from the first chamber 104₁ to another constituent in the second chamber 104₂. This transference may be based on a time-based degradability of a degradable component of the barrier 106, where the time-span at which the degradable component degrades is based on composition of the degradable component. Alternatively, the transference may be based on selective application of electrical or other forms of energy to a hydrophobic component thus making it into a hydrophilic component. Where there are more than two chambers (104₁,104₂), e.g., a four-chamber tray (not shown), there may be corresponding barriers (not shown) between the associated chambers (not shown). For example, as shown there may be a first barrier separating the first chamber 104₁ from the second chamber 104₂, a second barrier (not shown) separating the first chamber 104₁ from a third chamber (not shown), a third barrier (not shown) separating the second chamber 104₂ from a fourth chamber (not shown), and a fourth barrier (not shown) separating the third chamber (not shown) from the fourth chamber (not shown). Each of these barriers may be configured to be i) a permanent barrier, 2) a time-based degradable barrier, or 3) a selective barrier based on application of electrical or other forms of energy as discussed above and further discussed below.

The Lab-On-Chip system 100 further includes one or more light chamber assemblies 150 designed to provide an optical environment with a selective light wavelength without interference from ambient light or light from another chamber. Thus, each light chamber assembly 150 is to be placed over a corresponding chamber (104₁, 104₂) in the multi-chamber tray 102. Each light chamber assembly 150 includes a light chamber 152, shown as a conical structure, however, other shapes, e.g., cubical or other complex shapes, are within the scope of the present disclosure. For example, the light chamber 152 may have a cylindrical shape at its top position and transition to a rectangular shape at its bottom position matching outer surface of each chamber (104₁, 104₂) of the multi-chamber tray 102. Additionally, the light chamber includes one or more tabs 154 that match the shapes of the corresponding depressions 112 of the envelope 110 in each of the chambers (104₁, 104₂) of the multi-chamber tray 102. These tabs 154 are configured to be i) breakable (i.e., permanently removable), or ii) spring loaded to allow access to the cavity when pulled away but would spring back to a closed position when left alone. The light chamber 152 also includes mounting interfaces 156 configured to interface with matching mounting interfaces 114 of the multi-chamber tray 102.

The Lab-On-Chip system 100 further includes light sources 158, e.g., light emitting diodes, which may be interchangeable to provide light at different wavelength, pulse rate and intensity. The light sources 158 are configured to tightly fit the top of the light chamber 152 in an opening having a shape, e.g., cylindrical or cubical. The top opening of the light chamber 152 is also intended to fit the objective lens of a microscope (not shown) to allow inspection of constituents in the cavities of the multi-chamber tray 102. The light source 158 and can produce pulses, e.g., 20 kHz, of intensity at a desired intensity, e.g., 10,000 lux, however, other top-end frequency and intensities are withing the scope of the present disclosure. While the light source 158 may be interchangeable, in an alternative embodiment, the light source is matched to its corresponding light chamber 152, and the corresponding assembly is provided as package.

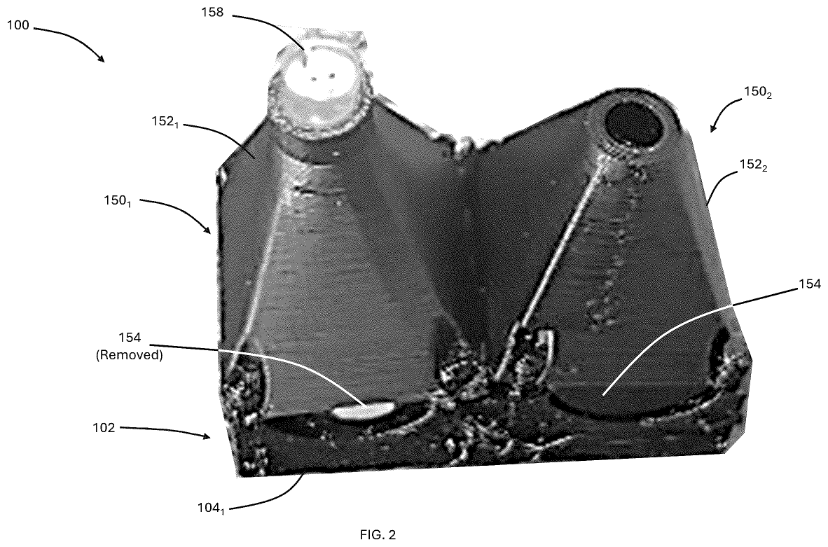

Referring to FIG. 2, a photograph of the Lab-On-Chip system 100 is shown in a partially assembled fashion where light chamber assembly 150₁ and 150₂ are placed on a two chamber multi-chamber tray 102 with light source 158 assembled atop the light chamber 152₁. One of the tabs of the light chamber 152₁ has been removed to show ability to inspect and access the constituent in the cavity of chamber 104₁, while the neighboring tab in the light chamber 152₂ has been left intact.

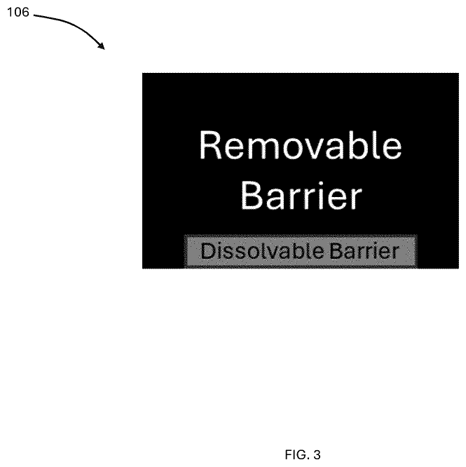

As discussed above, the barrier 106 (see FIG. 1) can be provided in three different embodiments. In the first embodiment, the barrier 106 is permanent and remains between two neighboring chambers (e.g., 104₁, 104₂, see FIG. 1). In the second embodiment, the barrier 106 includes a dissolvable portion towards the bottom section of the barrier 106 as shown in FIG. 3. The chemical makeup of the dissolvable portion may be chosen so that it dissolves after a predetermined amount of time. For example, by choosing a thin coat of controlled biodegradable material such as PLGA 15:85, PLGA 50:50, or a combination of hydrogels can be placed in the bottom half of the barrier 106 which would dissolve after a certain amount of time depending on which chemical composition is chosen. The main part of the barrier 106 may be removable, while the bottom portion of the barrier 106 (i.e., the dissolvable portion) remains in place to be dissolved after a certain amount of time.

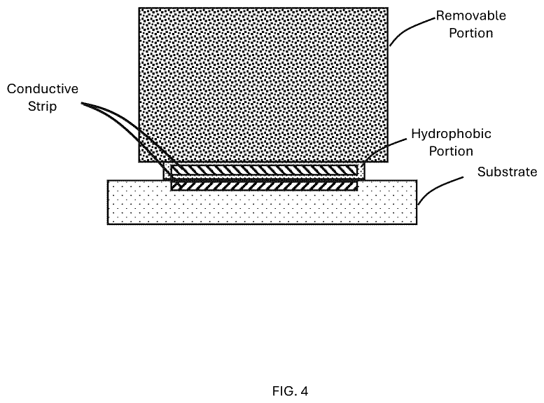

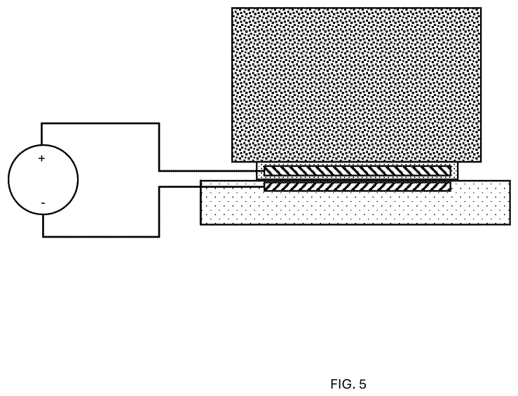

The third embodiment is shown in FIG. 4. In this embodiment, the barrier includes a removable portion and a hydrophobic portion (e.g., polyvinylidene fluoride (PVDF), parylene, or other polymers known to a person having ordinary skill in the art). The hydrophobic portion also includes an electrically, thermally or optically conductive strip, e.g., made of gold, functioning as an electrode. The barrier assembly shown in FIG. 4 is configured to be placed atop a substrate (e.g., made of glass) with a matching conductive strip. These conductive strips are coupled to an electrical voltage, light or heat source to provide energy to the hydrophobic layer which causes the hydrophobic layer to become hydrophilic thus allowing transference of constituents from one chamber to another chamber. Once the source is removed, the hydrophilic portion becomes hydrophobic again thus stopping transference of the constituents across the barrier. The circuit with the voltage source is shown in FIG. 5, not limiting the excitation of the hydrophobic layer by other energy types.

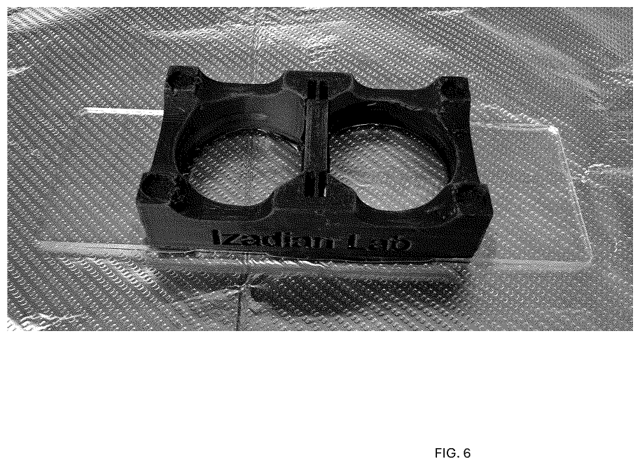

Referring to FIG. 6, the multi-chamber tray is shown with two chambers on a microscope slide. As discussed above, such a placement on the microscope slide allows for inspection of constituents in the chambers under the microscope.

Those having ordinary skill in the art will recognize that numerous modifications can be made to the specific implementations described above. The implementations should not be limited to the particular limitations described. Other implementations may be possible.

1. A Lab-On-Chip (LOC) system, comprising:
a multi-chamber tray having at least two chambers separated by a barrier;
one or more light chambers each having a top portion and a bottom portion, and configured to be coupled to each chamber of the multi-chamber tray and further configured to allow selective light from the top portion of the light chamber, while blocking surrounding light; and
one or more light sources, each coupled to a top portion of a corresponding one or more light chamber, wherein each of the one or more light sources is selectively configured to provide light at a predetermined wavelength, a predetermined frequency, and a predetermined intensity.

2. The LOC system of claim 1, wherein the barrier is at least one of a solid barrier configured to prevent transference of constituents from one chamber to a neighboring chamber, a removable barrier thus allowing transference of constituents from one chamber to a neighboring chamber, a barrier having a solid portion and a dissolvable portion configured to prevent transference of constituents from one chamber to a neighboring chamber, and wherein the dissolvable portion is dissolvable after a predetermined amount of time, and a barrier with a solid portion a hydrophobic portion configured to prevent transference of constituents from one chamber to a neighboring chamber, and wherein the hydrophobic portion is reversibly configured to be converted to a hydrophilic portion thus allowing transference of constituents from one chamber to a neighboring chamber when energy is applied to said hydrophilic portion.

3. The LOC system of claim 2, wherein the dissolvable portion is made of Poly(lactic-co-glycolic acid) (PLGA) 15:85, PLGA 50:50, a hydrogel, or a combination thereof.

4. The LOC system of claim 1, wherein the one or more light sources are configured to provide a steady state light of a selectable intensity.

5. The LOC system of claim 1, wherein the one or more light sources are configured to provide light pulses.

6. The LOC system of claim 5, wherein an upper limit of the pulse frequency is 20 kHz.

7. The LOC system of claim 1, wherein the one or more light sources are configured to provide light at a predetermined intensity having an upper limit of 10,000 lux.

8. The LOC system of claim 1, wherein each of the one or more light chambers includes tabs that interface with depressions formed on the multi-chamber tray.

9. The LOC system of claim 8, wherein the tabs are removable.

10. The LOC system of claim 8, wherein the tabs are spring loaded, allowing access to a corresponding chamber when pulled back or pushed in and wherein the tabs return to a closure position when released.

11. A method of mixing constituents on a Lab-On-Chip (LOC) system, comprising:
providing a plurality of constituents, each in a corresponding chamber in a multi-chamber tray, each chamber separated from a neighboring chamber by a barrier;
coupling a plurality of light chambers each having a top portion and a bottom portion to each chamber of the multi-chamber tray and further configured to allow selective light from the top portion of the corresponding light chamber, while blocking surrounding light including light from a neighboring light chamber; and
applying light by a plurality of light sources, each coupled to a top portion of a corresponding light chamber, wherein each of the one or more light sources is selectively configured to provide light at a predetermined wavelength, a predetermined frequency, and a predetermined intensity.

12. The method of claim 11, wherein the barrier is at least one of a solid barrier configured to prevent transference of constituents from one chamber to a neighboring chamber, a removable barrier thus allowing transference of constituents from one chamber to a neighboring chamber, a barrier having a solid portion and a dissolvable portion configured to prevent transference of constituents from one chamber to a neighboring chamber, and wherein the dissolvable portion is dissolvable after a predetermined amount of time, and a barrier with a solid portion a hydrophobic portion configured to prevent transference of constituents from one chamber to a neighboring chamber, and wherein the hydrophobic portion is reversibly configured to be converted to a hydrophilic portion thus allowing transference of constituents from one chamber to a neighboring chamber when energy is applied to said hydrophilic portion.

13. The method of claim 12, wherein the dissolvable portion is made of Poly(lactic-co-glycolic acid) (PLGA) 15:85, PLGA 50:50, a hydrogel, or a combination thereof.

14. The method of claim 11, wherein the plurality of light sources are configured to provide a steady state light of a selectable intensity.

15. The method of claim 11, wherein the plurality of light sources are configured to provide light pulses.

16. The method of claim 15, wherein an upper limit of the pulse frequency is 20 KHz.

17. The method of claim 11, wherein the plurality of light sources are configured to provide light at a predetermined intensity having an upper limit of 10,000 lux.

18. The method of claim 11, wherein each of the plurality of light chambers includes tabs that interface with depressions formed on the multi-chamber tray.

19. The method of claim 18, wherein the tabs are removable.

20. The method of claim 18, wherein the tabs are spring loaded, allowing access to a corresponding chamber when pulled back or pushed in and wherein the tabs return to a closure position when released.
